(19) United States
(12) Patent Application Publication
(10) Pub. No.: US 2008/0176162 A1
(43) Pub. Date: Jul. 24, 2008

(54) TONER AND PREPARATION METHOD THEREOF

(75) Inventors: Ken OHMURA, Tokyo (JP); Hiroshi YAMAZAKI, Tokyo (JP); Tomomi OSHIBA, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 11/960,070

(22) Filed: Dec. 19, 2007

(30) Foreign Application Priority Data
Jan. 22, 2007 (JP) 2007011115

(51) Int. Cl. G03G 9/08; G03G 9/10

(52) U.S. Cl. 430/110.3; 430/137.15

(57) ABSTRACT

Disclosed is a toner comprising toner particles comprising a binding resin and a colorant, wherein the toner particles exhibit an average circularity of 0.950 to 0.980, a volume-base median diameter of 4.5 to 8.0 μm and a volume-based particle size dispersion degree (CVᵥₒₗ) of 15 to 25 and contain a metal element selected from the group consisting of titanium, germanium and aluminum in an amount of 10 to 1500 ppm. A manufacturing method of the toner is also disclosed.

### FIELD OF THE INVENTION

The present invention relates to a toner used for an image forming method of an electrophotographic system and a preparation method thereof.

### BACKGROUND OF THE INVENTION

In recent years, electrophotographic image forming apparatuses have been used not only as usual copiers or printers for printing or copying intra-office documents but also in the field of preparation of printed materials for extra-office use, specifically, since variable information can be readily printed from electronic data, their use has been expanded to the printing on-demand (POD) market in the area of short-run printing. Along therewith, plural copiers or printers have been installed in offices, resulting in increased electric power consumption.

In the POD market, values are required for the printing material itself, not to conduct printing, so that the printing material calls for high quality image formation.

In order to obtain printed material of high image quality, reduction of the toner particle size is known to be effective and there have been proposed various chemical toners to achieve this. Such a chemical toner, which is prepared by the process of granulation in an aqueous medium, has an advantage that fine toner particles of high uniformity can be obtained, in contrast to a pulverization method.

As is also known, the use of polyester resin as a binding resin for toner particles is effective to obtain printed material of high image quality with high glossiness, without causing an offset phenomenon in fixing.

There was proposed a method of preparing fine toner particles by using a polyester resin, in which the polyester resin dissolved or dispersed in a solvent was dispersed in an aqueous medium to form oil-droplets, followed by removal of the solvent to obtain toner particles.

There are generally used tin compounds such as dibutyl tin as a catalyst used for synthesis of polyester resin through polycondensation, as described in, for example, JP-A No. 2005-173570 (hereinafter, the term, JP-A refers to Japanese Patent Application).

In the foregoing method, however, after dissolving or dispersing a colorant together with polyester resin in a solvent, granulation is performed, producing problems of deteriorated dispersibility of the colorant in the obtained toner particles.

Further, the tin compounds used as a catalyst are organo-tin compounds having an aliphatic group with an attached metal (tin). Recently, organo-tin compounds were pointed to show problems of safety in environmental suitability and the use of such a catalyst has been reexamined.

Recently, in view of such environmental consideration, there were proposed titanium catalysts such as titanium halogenate, titanium ketonate, titanium carboxylate, titanyl carboxylate and titanyl carboxylate salt; and metal catalysts such as a germanium catalyst and an aluminum catalyst, as disclosed in JP-A Nos. 2004-126544, 2005-91696 and 2005-91525.

### SUMMARY OF THE INVENTION

In view of the foregoing background, the present invention has come into being and it is an object of the invention to provide a toner which can achieve high image density and broad color reproduction and also realize a high quality image.

As a result of study of the inventors, it was discovered that a metal element selected from titanium, germanium and aluminum (hereinafter, also denoted as a specific catalytic metal element) which is contained in a specific amount in toner particles, achieved high dispersibility of the colorant in a polyester resin. It was further discovered that high dispersibility of colorants in a polyester resin was attained when a catalyst compound (hereinafter, also denoted as a specific catalyst compound) supplying the foregoing specific catalytic metal element was not simply added at the time of dispersing a colorant but was allowed to function as a catalyst for synthesis of a polyester segment to form a polyester resin and remain therein.

Thus, one aspect of the invention is directed to a toner comprising toner particles containing a binding resin composed of a polyester resin and a colorant, wherein the toner particles exhibit an average circularity of 0.950 to 0.980, a volume-based median diameter of 4.5 to 8.0 μm and a volume-based particle size dispersion degree (CVᵥₒₗ value) of 15 to 25 and contain a metal element selected from the group consisting of titanium, germanium and aluminum in an amount of 10 to 1500 ppm.

In the toner of the invention, the metal element is contained in the form of being dispersed in a binding resin constituting toner particles.

Another aspect of the invention is directed to a method of preparing a toner comprising dissolving or dispersing a polyester segment to form a polyester resin and a colorant in a solvent to form a toner forming material solution, dispersing the toner forming material solution in an aqueous medium in the form of oil-droplets dispersed in the aqueous medium, and performing granulation from the oil-droplets to form toner particles, wherein the polyester segment to form a polyester resin is obtained by subjecting a polyol and a polycarboxylic acid to polycondensation in the presence of a metal ion selected from the group consisting of titanium, germanium and aluminum.

In the toner of the invention, toner particles comprise a polyester resin and exhibit a specific minute particle size, whereby a high quality image can be obtained; exhibiting a specific sharp particle size dispersion degree, whereby formation of excessively smaller toner particles or excessively larger particles is inhibited and a high density of toner particles is achieved in fixing; exhibiting a specific irregular form, whereby the space between toner particles can be minimized and closer contact of toner particles is achieved in fixing, preventing diffusion of the toner and leading to enhanced fine line reproducibility and a high image density; and containing a specific catalytic metal element in a specific amount, whereby enhanced dispersibility of a colorant in a binding resin of fine toner particles is enhanced, whereby a high image density and a broad color reproduction range are achieved even at a reduced power consumption and a high quality image is realized.

The reason that high dispersion of a colorant can be achieved is not clear but it is presumed that titanium, germanium or aluminum has a structure characteristic to a metal atom and easily forms a coordination structure for a compound constituting a colorant, achieving high dispersibility of a colorant in a polyester resin.

In the manufacturing method of a toner according to the invention, a specific catalytic compound is used in synthesis of the polyester segment and still remains therein, resulting in homogeneous existence of the catalytic compound in a polyester and the catalytic compound being oriented for a colorant, achieving enhanced dispersion of the colorant, whereby a toner containing a colorant highly dispersed in a polyester resin is obtained.

The toner of the invention contains a binding resin comprised of a polyester resin and a colorant and further contains a specific catalytic metal element exhibiting an average circularity of 0.950 to 0.980, a volume-based median diameter of 4.5 to 8.0 μm and a volume-based particle size dispersion degree (CVᵥₒₗ value) of 15 to 25.

### Average Toner Particle Size

The average particle size of the toner of the invention which is represented by volume-based median diameter, is from 4.5 to 8.0 μm. An average particle size falling within the foregoing range of a volume-based median diameter reduces adhesive particles which fly to the heating roller and adhere thereto, often causing offset, and results in an enhanced transfer efficiency, leading to enhanced image quality of halftone images and enhanced image quality of fine lines or dots.

The average particle size of the toner of the invention can be controlled by concentration of a coagulating agent or addition amount of an organic solvent and coagulation time in the coagulation step, and the composition of the polyester resin.

The volume-based median diameter (D₅₀) of toner particles can be determined using Coulter Multisizer 3 (Beckmann Coulter Co.), connected to a computer system for data processing.

The measurement procedure is as follows: 0.02 g of toner particles are added to 20 ml of a surfactant solution (for example, a surfactant solution obtained by diluting a surfactant containing neutral detergent with pure water to a factor of 10) and dispersed in an ultrasonic homogenizer to prepare a toner dispersion. Using a pipette, the toner dispersion is placed into a beaker containing ISOTON II (produced by Beckman Coulter Co.) within a sample stand, until reaching a measurement concentration of 7%. The measurement particle count number was set to 25000 to perform measurement. Then aperture diameter of the Multisizer 3 was 50 μm. The measurement range of 1 to 30 μm was divided into 256 portions to determine the frequency number. A particle size corresponding to 50% of the volume-integrated fraction from the larger particles was defined as a volume-based median diameter.

### Volume-based Particle Size Dispersion Degree (CVᵥₒₗ)

The volume-based particle size dispersion degree (which is also denoted simply as CVᵥₒₗ value) of the toner of the invention is from 15 to 25, and preferably from 15 to 22.

The volume-based particle size dispersion degree (CVᵥₒₗ value), which refers to a coefficient of variation of volume-based particle size distribution, is defined by equation (x) described below. In the equation (x), the arithmetic average value of volume-based particle size is a value calculated for 25,000 particles, which is measured by Coulter Multisizer III (Beckmann Coulter Co.):

CVᵥₒₗ value (%)={(standard deviation of volume-based particle size distribution)/(arithmetic average value of volume-based particle size)}×100 Equation (x)

When the arithmetic average value of volume-based particle size is low, formation of excessively small toner particles or excessively large particles is inhibited and a high density of toner particles is achieved in fixing, producing prints of enhanced fine line reproducibility and high image density.

### Average Circularity

In the toner of the invention, the average circularity of toner particles is in the range of 0.950 to 0.980, and preferably 0.955 to 0.975. An average circularity falling within the foregoing range results in prints of high reproducibility of fine lines and high image density. It is assumed that conventional toner particles of relatively small sizes are relatively thin so that the coverage rate per particle is low, and spaces between toner particles affect reproducibility of fine lines formed of single-layered toner particles, rendering it difficult to achieve high reproduction of fine lines and high image density. On the other hand, toner particles of an irregular form minimize spaces between particles.

The circularity of toner particles can be determined using FPIA-2100 (produced by Sysmex Co.). Concretely, toner particles are added into an aqueous surfactant solution, dispersed ultrasonically for 1 min. and subjected to measurement using FPIA-2100. The measurement condition is set to HPF (high power flow) mode and measurement is conducted at an optimum concentration of the HPF detection number of 3,000 to 10,000. The circularity of a particle is determined according to the following equation (z), circularities of toner particles are summed and divided by the number of total particles to obtain the circularity of the toner particles:

Circularity={(circumference of a circle having an area equivalent to the projected area of a particle)/(a circumference of the projected particle)}. Equation (z)

The toner particles contain a specific catalytic metal element selected from titanium, germanium and aluminum in an amount of 10 to 1500 ppm. The content of the metal element can be determined by commonly known metal analysis methods such atomic absorption spectrometry or plasma emission spectrometry. The content of a specific catalytic metal element in the toner particles of the invention can be determined in a high frequency plasma emission spectrometer SPS 1200A (produced by Seiko Denshi Kogyo Co., Ltd.).

The specific catalytic metal element is one or more selected from titanium, germanium and aluminum. The specific catalytic metal element is contained preferably in the form of an organic metal compound or a metal oxide, and more preferably in the form of an organic metal compound. Such an organic metal compound preferably has a backbone of a metal alcoholate or the like.

The content of a specific catalytic metal element falling with the foregoing range can achieve enhanced dispersibility of a colorant in a polyester resin. When the content of a specific catalytic metal element is excessively large, a toner obtained in the presence of the excessive metal element exhibits low electric resistance and easily causes charge leakage and results in reduced charging capability specifically when used under an environment of high temperature. On the contrary, when the content of a specific catalytic metal element is excessively small, sufficient dispersibility of a colorant cannot be achieved.

### Manufacture of Toner

The toner of the invention can be manufactured by employing so-called molecular growth of particles in an aqueous medium. Specifically, a toner comprising toner particles containing a binding resin comprised of a polyester resin and a colorant can be manufactured by a process comprising preparing a polyester segment, dispersing or dissolving the polyester segment and the colorant in a solvent to prepare a toner forming material solution, dispersing the solution in an aqueous medium in the form of oil-droplets dispersed in the aqueous medium, and performing granulation from the oil-droplets in the aqueous medium to form the toner particles.

The polyester segment to form a polyester resin is obtained by polycondensation of a polyol and a polycarboxylic acid in the presence of a specific catalytic metal ion. The specific catalytic metal ion is supplied to a synthesis reaction system of a polyester segment preferably in the form of a catalyst compound as described above.

More specifically, a manufacturing method of a toner relating to the invention comprises (1-1) a polyester segment synthesis step of synthesizing a polyester (hereinafter, also denoted as a polyester segment) in the presence of a catalyst, (1-2) an isocyanate-modification step of modifying the polyester segment obtained in the foregoing step (1-1) with an isocyanate to synthesize an isocyanate-modified polyester segment, (2) a preparation step of a toner forming material solution by adding a cross-linking agent (or molecular elongation agent),a colorant, optionally a wax and a solvent to the isocyanate-modified polyester segment to prepare a solution of materials to form a toner (which is hereinafter also denoted as a toner forming material solution), (3) dispersion step of dispersing the toner forming material solution in an aqueous medium to oil-droplets of the material solution dispersed in the aqueous medium, (4) molecular elongation step of performing molecular elongation within the droplets to obtain a polyester resin, (5) coagulation step of coagulating the oil-droplets in the aqueous medium, (6) solvent removal step of removing the solvent from the coagulated oil-droplets to obtain colored particles, (7) filtration and washing step of filtering off the obtained colored particles from the aqueous medium and washing the colored particles to remove a surfactant and the like, (8) drying step of drying the washed particles, and (9) external additive addition step of adding external additives to the dried colored particles to obtain toner particles.

In the following, there will be detailed the manufacturing method.

### (1-1) Polyester Segment Synthesis Step:

In this step, a polyol component and a polycarboxylic acid component are allowed to react in the presence of a specific catalytic metal element ion preferably at a temperature of 150 to 280° C. (more preferably 170 to 260° C.), and optionally under reduced pressure with distilling formed water to form a polyester segment having a hydroxyl group or a carboxyl group. Specifically, a mixture of a polyol component, a polycarboxylic acid component and a specific catalyst compound is allowed to exist under reaction conditions to synthesize a polyester segment.

A reaction temperature of less than 150° C. retards the reaction and cannot often achieve sufficient solubility of a polycarboxylic acid component in a polyol component. A reaction temperature of more than 280° C. has concerns for decomposition of raw material.

Aromatic diols are preferred as a polyol component to synthesize a polyester segment and examples of an aromatic diol include bisphenols such as bisphenol A and bisphenol F, and alkylene oxide additives of these bisphenols such as ethylene oxide additive or propylene oxide additive of these bisphenol. These may be used singly or in combination.

In addition to aromatic diols, there may be added aliphatic diols such as ethylene glycol, diethylene glycol, triethylene glycol, 1,2-propylene glycol, 1,3-propylene glycol, 1,4-butanediol, 1,4-butenediol, neopentyl glycol, 1,5-pentane glycol, 1,6-hexane glycol, 1,7-heptane glycol, 1,8-octanediol, 1,9-nonanadiol, 1,10-decanediol, 1,4-cyclohexanediol and dipropylene glycol. In that case, an aromatic dial preferably accounts for at least 50% by mass of the total dial component. When an aromatic diol accounts for less than 50% by mass of the total diol component, an appropriate viscoelasticity cannot be obtained, often causing a high temperature offset phenomenon and it is concerned that high-speed fixability cannot be accomplished.

To control a melting point of a polyester resin, there may be added a small amount of an aliphatic polyol having a valence of three or more, such as glycerin, trimethylol ethane, trimethylol propane, pentaerythritol, and sorbitol.

Examples of a polycarboxylic acid used for synthesis of a polyester segment include dicarboxylic acids such as oxalic acid, malonic acid, succinic acid, glutaric acid, adipic acid, pimelic acid, suberic acid, azelaic acid, sebacic acid, maleic acid, fumaric acid, citraconic acid, itaconic acid, glutaconic acid, n-dodecylsuccinic acid, n-dodecenylsuccinic acid, isododecylsuccenic acid, isododecenylsuccinic acid, n-octylsuccinic acid and n-octenylsuccinic acid and their acid anhydrides and acid chlorides. In addition to the foregoing aliphatic dicarboxylic acids, there may be cited aromatic dicarboxylic acids such as phthalic acid, isophthalic acid, terephthalic acid and naphthalenedicarboxylic acid, and carboxylic acid having a valence of 3 or more, such as trimellitic acid and pyromellitic acid may also be used to control the melt viscosity of a polyester resin.

The ratio of the polyol component to the polycarboxylic acid component, which is a molar ratio of hydroxy group [OH] of a polyol component to carboxyl group [COOH] of a polycarboxylic acid, i.e., [OH]/{COOH}, is preferably from 1.5/1 to 1/1.5, and more preferably from 1.2/1 to 1/1.2. A ratio of polyol to polycarboxylic acid falling within the foregoing range can certainly obtain a polyester segment having the intended molecular weight.

As a specific catalyst compound are cited organic metal compounds and metal oxides, specifically an organic metal compound having a backbone of a metal alcoholate. Specific examples of a titanium compound supplying titanium as a specific catalyst metal element include titanium alkoxides such as tetra-n-butyltitanate, tetra(2-ethylhexyl)titanate, tetraisopropyltitanate, tetramethyltitanate and tetrastearyl titanate; titanium acrylate such as polyhydroxytitanium stearate; titanium chelates such as titanium tetraacetylacetonato, titanium octylene glycolate, titanium ethylacetoacetate, titanium lactate and titanium triethanolaminate.

Aluminum compounds supplying aluminum include an oxide such as poly(aluminum hydroxide) and an aluminum alkoxide. Specific examples thereof include tributylaluminate, trioctylaluminate and tristearylaluminate. These may be used singly or in combination.

The foregoing catalyst compound is used preferably in an amount of 0.01 to 1.00% by mass of the total of a polyol component and a polycarboxylic acid.

The catalyst compound may be added at the start of or in the course of polycondensation reaction. Supplemental addition of the catalyst compound in the course of polycondensation can control the content of a specific metal element of the obtained toner.

The glass transition point (Tg) of the obtained polyester segment is preferably from 35 to 65° C.

The softening point of a polyester segment derived from an aromatic diol is preferably from 80 to 220° C. and more preferably from 80 to 150° C.

The measurement of the glass transition point (Tg) is conducted as follows. A toner of 4.5 mg is precisely weighed, sealed into an aluminum pan (KIT NO. 0219-0041) and set into a DSC-7 sample holder. An empty aluminum pan is used as a reference. The temperature was controlled through a mode of heat-cool-heat at a temperature-raising rate of 10° C./min and a temperature-lowering rate of 10° C./min in the range of 0 to 200° C. An extension line from the base-line prior to the initial rise of the first endothermic peak and a tangent line exhibiting the maximum slope between the initial rise and the peak are drawn and the intersection of both lines is defined as the glass transition point (Tg). The 1st heat was maintained at 200° C. for 5 min.

The softening point was measured as follows. First, under an environment of 20° C. and 50% RH, 1.1 g of a polyester segment was placed into a petri dish, leveled, allowed to stand for at least 12 hrs., and compressed under a pressure of 3820 kg/cm² for 30 sec. by using a molding machine to prepare a cylindrical molded sample of 1 cm diameter. Subsequently, the molded sample is extruded by using a piston of 1 cm diameter through a hole (1 mm diameter×1 mm) under an environment of 24° C. and 50% RH by using a flow test CFT-500D (produced by Shimazu Seisakusho) under conditions of a load of 196 N (20 kgf), a start temperature of 60° C., a pre-heating time of 300 sec. and a temperature increasing rate of 6° C./min. An offset method temperature T_{offset} which was measured at an offset value of 5 mm in a melting temperature measurement of a temperature raising method was defined as the softening point.

The obtained polyester segment preferably exhibits a number average molecular weight (Mn) of 2,000 to 10,000 (more preferably 2,500 to 8,000) and a weight average molecular weight (Mw) of 3,000 to 100,000 (more preferably 4,000 to 70,000), which were determined by gel permeation chromatography (GPC) of tetrahydrofuran (THF) solubles. Measurement of molecular weight by GPC is conducted as follows. Using an apparatus HLC-8220 (produced by TOSOH CORP.) and a column TSK guard column +TSK gel Super HZM-M3 (produced by TOSOH CORP.), THF as a carrier solvent is fed at a flow rate of 0.2 ml/min, while maintaining a column temperature of 40° C. A sample is dissolved in THF at room temperature so as to have a concentration of 1 mg/ml, while dispersing for 5 min. by using an ultrasonic dispersing machine and then filtered by a membrane filter of 0.2 μm pore size to obtain a sample solution. Then, 10 μl of this sample solution is injected with carrier gas into the GPC and is detected by a refractive index detector (RI detector). In the molecular weight measurement of a sample, the molecular weight distribution of the sample is calculated using a calibration curve prepared by using monodisperse polystyrene standard particles. About 10 points are preferably used for the calibration curve of polystyrene. Monodisperse standard polystyrene samples used those produced by Pressure Chemicals Co., having a molecular weight of 6×10², 2.1×10³, 4×10³, 1.75×10⁴, 5.1×10⁴, 1.1×10⁵, 3.9×10⁵, 8.6×10⁵, 2×10⁶ and 4.48×10⁶. As a detector was used a refractive index detector.

### (1-2) Isocyanate-modification Step:

In this step, a polyvalent isocyanate compound (also denoted as a polyisocyanate compound) is reacted with a polyester segment synthesized in the foregoing step (1-1) to substitute a hydroxyl group and/or a carboxyl group at the molecular end of the polyester segment by an isocyanate group to obtain an isocyanate-modified polyester segment. In the reaction of a polyisocyanate compound, there may be used inert solvents for the polyisocyanate compound. Examples of such solvents include ketones such as acetone, methyl ethyl ketone, and methyl isobutyl ketone; esters such as ethyl acetate; amides such as dimethyl formamide and dimethyl acetoamide; ethers such as tetrahydrofuran; aromatic solvents such as toluene and xylene.

Examples of a polyisocyanate compound used for isocyanate-modification of a polyester segment include aliphatic polyisocyanate compounds such as tetramethylenediisocyanate, hexamethylenediisocyanate and 2,6-diisocyanatomethylcaproate; alicyclic polyisocyanate compounds such as isophoronediisocyanate and cyclohexylmethanediisocyanate; aromatic diisocyanate compounds such as tolylenediisocyanate and diphenylmethanediisocyanate; aroma-aliphatic diisocyanate compounds such as α, α, α′, α′-tetramethylxylilenediisocyanate; isocyanurates; phenol derivatives of these polyisocyanate compounds and oxime- or caprolactam-blocked polyisocyanate compounds. These polyisocyanate compounds may be used singly or in combination.

### (2) Preparation of a Toner Forming Material Solution:

In this step, toner constituting materials constituted of an isocyanate-modified polyester segment as obtained above, binding resin constituting component composed of an amine cross-linking agent, a colorant, and optionally a wax and a charge-controlling agent were dissolved or dispersed in an organic solvent to prepare a toner forming material solution.

The polyester segment contained in the toner forming material solution is not limited to an isocyanate-modified polyester segment but used in combination therewith may be an unmodified polyester segment.

Organic solvents usable for preparation of the toner forming material solution are preferably those exhibiting a low boiling point and low solubility in water and specific examples of such organic solvents include methyl acetate, methyl ethyl ketone, methyl isobutyl ketone, toluene and xylene, which may be used singly or in combination.

Such an organic solvent is used preferably in an amount of 1 to 300 parts by mass, more preferably 1 to 100 parts by mass, and still more preferably 25 to 70 parts by mass, based on 100 parts by mass of an isocyanate-modified polyester segment.

Specific examples of an amine cross-linking agent as a binding resin constituting component include diamines of aromatic diamines such as phenylenediamine, diethyltoluenediamine and 4,4′-diaminodiphenylmethane, alicyclic diamines such as 4,4′-diamino-3,3′-dimethyldicyclohexylmethane, diaminecyclohexane and isophoronediamine, and aliphatic diamines such as ethylenediamine, tetramethylenediamine, and hexamethylenediamine; aminoalcohols such as thanol amine and hydroxyethylaniline; aminomercaptanes such as aminoethylmercaptane and aminopropylmercaptane; amino acids such as aminopropionic acid and aminocapronic acid and their amino-blocked compounds such as a ketimine compound obtained by reaction with a ketone such as acetone, methyl ethyl ketone or methyl isobutyl ketone and an amino-blocked oxazolidine compound. These compounds may be used singly or in combination.

In the manufacturing method of the invention, diamine compounds are preferably used as an amine cross-linking agent but to control the melt viscosity of a polyester resin, a diamine compound may be used in combination with a small amount of a polyamine having an amine valence of three or more. This is because an unreacted amino-endo group remaining in the obtained polyester resin may make it difficult to achieve uniform charging of the toner.

The molecular weight of the obtained polyester resin can be controlled optionally by the use of an elongation-terminating agent. Examples of such an elongation-terminating agent include monoamines such as diethylamine, dibutylamine, butylamine and laurylamine and their blocked compounds such as ketimine.

The toner forming material solution contains an amine cross-linking agent preferably in amount of 0.1 to 5 parts by mass, based on 100 parts by mass.

As colorants constituting the toner of the invention are usable carbon black, magnetic materials, dyes and pigments. There are used carbon black such as Channel black, Furnace Black, Channel Black, Acetylene Black, Thermal Black and Lamp Black. Magnetic materials include ferromagnetic metals such as iron, nickel and cobalt and their alloys; ferromagnetic metal compounds such as ferrite and magnetite; alloys containing no ferromagnetic metal but exhibiting ferromagnetism upon a thermal treatment, for example, a so-called Whisler alloy such as manganese-copper-aluminum and manganese-copper-tin, and chromium dioxide.

Dyes usable in the invention include C.I. Solvent Red 1, ibid 49, ibid 52, ibid 58, ibid 63, ibid 111 and ibid 122; C.I. Solvent Yellow 19, ibid 44, ibid 77, ibid 79, ibid 81, ibid 82, ibid 93, ibid 98, ibid 103, ibid 104, ibid 112, and ibid 162; and C.I. Solvent Blue 25, ibid36, ibid 60, ibid 70, ibid 93 and ibid 95. There are also usable a mixture of these dyes. Pigments include C.I. Pigment Red 5, ibid 48:1, ibid 53:1, ibid 57:1, ibid 122, ibid 139, ibid 144, ibid 149, ibid 166, ibid 177, ibid 178, ibid 222; C.I. Pigment Orange 31 and ibid 43; C.I. Pigment Yellow 14, ibid 17, ibid 74, ibid 93, ibid 94, ibid 138, ibid 155, ibid 180 and ibid 185; C.I. Pigment Green 7; C.I. Pigment Blue 15:3 and ibid 60 and their mixtures.

Wax is optionally used but is not specifically limited. Commonly known waxes are usable and examples thereon include hydrocarbon wax such as low molecular weight polyethylene wax, low molecular weight polypropylene wax, Fischer-Tropsch wax, microcrystalline wax and paraffin wax; ester waxes such as Carnauba wax, pentaerythritol behenic acid ester and behenyl citrate. These are used singly or in their combination.

Charge controlling agents are optionally used but are not specifically limited. Specific examples thereof include a Nigrosine dye, metal salts of naphthenic acid of higher fatty acid, alkoxylated amines, quaternary ammonium salt compounds, azo-type metal complexes, and a salicylic acid metal salt and its complexes.

The toner forming material solution contains a colorant preferably in an amount of 1 to 15% by mass, and more preferably 4 to 10% by mass, based on total solids.

The toner forming material solution contains a wax preferably in an amount of 2 to 20% by mass, and more preferably 3 to 18% by mass, based on total solids.

The toner forming material solution contains a charge controlling agent preferably in an amount of 0.1 to 2.5% by mass, and more preferably 0.5 to 2.0% by mass, based on total solids.

### (3) Dispersion Step:

In the step (3), the toner forming material solution obtained in the foregoing step (2) is added to an aqueous medium and dispersed therein to form oil-droplets whose particle size is controlled so as to obtain colored particles of a targeted particle size.

Emulsifying dispersion can be conducted by employing mechanical energy. Dispersing machines to perform emulsifying dispersion are not specifically limited but examples thereof include a low-speed shearing dispersing machine, a high-speed shearing dispersing machine, a friction-type dispersing machine, a high-pressure jet dispersing machine and an ultrasonic dispersing machine.

The number average primary particle size of oil-droplets is preferably from 60 to 1000 nm, and more preferably from 80 to 500 nm. The number average primary particle size of oil-droplets can be determined via an electrophoretic light scattering photometer ELS-800 (produced by Otsuka Denshi Co., Ltd.).

The aqueous medium refers to a medium containing water in an amount of at least 50% by mass. As components other than water is cited water-soluble organic solvents and examples thereof include methanol, ethanol, isopropanol, butanol, acetone, methyl ethyl ketone and tetrahydrofuran. Of these solvents, it is preferred to use organic solvents which do not dissolve a resin, for example, alcoholic solvents such as methanol, ethanol, isopropanol and butanol. The amount of the aqueous medium is preferably from 50 to 2,000 parts by weight and more preferably from 100 to 1,000 parts by mass, based on 100 parts by mass of a toner forming material solution. An amount of the aqueous medium, falling within the foregoing range can achieve emulsifying dispersion of the toner forming material solution in the aqueous medium.

A dispersion stabilizer is dissolved in the aqueous medium. Further, surfactants are also added to the aqueous medium to achieve enhanced dispersion stability of oil-droplets.

Examples of a dispersion stabilizer include inorganic compounds such as tricalcium phosphate, calcium carbonate, titanium oxide, colloidal silica and hydroxy-apatite. Of these, an acid- or alkali-soluble dispersion stabilizer such as tricalcium phosphate is preferred in terms of necessity of removing the dispersion stabilized from the obtained colored particles and the use of an enzyme-degradable one is preferred in terms of environment concern.

Exemplary surfactants include anionic surfactants such as an alkylbenzenesulfonate, an α-olefin sulfonate, and a phosphoric acid ester; cationic surfactants including an amine salt type such as an alkylamine salt, an aminoalcohol fatty acid derivative, and a quaternary ammonium alt type such as an alkyltrimethylammonium, a dialkyldimethylammonium salt, an alkyldimethylbenzylammonium salt, pyridinium salt, an alkylisoquinolinium and benzetonium chloride; nonionic surfactants such as fatty acid amide derivatives, polyol derivatives; amphoteric surfactants such as alanine, dodecyl-di-(aminoethyl)glycine, di(octylaminoethyl)glycine and N-alkyl-N,N-dimethylammonium betaine. Anionic or cationic, fluoroalky-containing surfactants are also usable.

### (4) Molecular Elongation Step:

In the step (4), within the oil-droplets dispersed in the aqueous medium and formed in the step (3), an isocyanate group of an isocyanate-modified polyester segment is allowed to react with an amine crosslinking agent through crosslinking reaction to form a urea bond, whereby molecular elongation is performed and a urea-modified polyester resin is produced. Thus, this step produces oil-droplets formed of polyester microparticles composed of a binding resin of the foregoing urea-modified polyester resin and containing a colorant and optionally wax.

The crosslinking reaction time via an amine crosslinking agent (or molecular elongation time), depending on the kind of raw material and the amine crosslinking agent, is preferably 1 to 24 hrs. and more preferably 2 to 15 hrs. The reaction temperature is preferably 20 to 100° C., and more preferably 50 to 98° C.

In the steps (2)-(4), an amine crosslinking agent is preliminarily contained in oil-droplets dispersed in the aqueous medium. Alternatively, an amine crosslinking agent is not preliminarily contained in the toner forming material solution and after dispersing the toner forming material solution in an aqueous medium to form oil-droplets, an amine crosslinking agent may be added to the aqueous medium. In that case, the amine crosslinking agent is supplied from the aqueous medium to the oil-droplets, in which an isocyanate group of an isocyanate-modified polyester is reacted with the amine crosslinking agent to undergo crosslinking reaction to form a urea bond, whereby a urea-modified polyester resin is produced.

### (5) Coagulation Step:

In the step (5), oil-droplets formed of polyester microparticles, obtained in the step (4) are allowed to coagulate to form colored particles.

Specifically, the dispersion stability of dispersed oil-droplets is lowered to cause coagulation. Methods for causing coagulation of the oil-droplets are not specifically limited but lowering dispersion stability include a method (X) of raising the temperature of an aqueous medium having oil-droplets dispersed and a method (Y) of adding a coagulant to an aqueous medium. Of these methods, the method (X) is simpler and therefore preferred. In the method (X), the temperature causing coagulation of oil-droplets is not specifically limited but typically from 50 to 98° C., and preferably from 60 to 90° C. Continuation of coagulation of oil-droplets results in growth of the coagulated oil-droplet particles. The duration of continued coagulation is not specifically limited so long as it is a time to reach the targeted particle size but is, typically from 1 to 10 hrs, and preferably from 2 to 8 hrs.

In the foregoing steps (4) and (5), there may be concurrently performed molecular elongation reaction and coagulation of polyester microparticles.

After completion of the coagulation step, it is preferred to conduct a treatment for shape control. In the shape control treatment, a dispersion of colored particles obtained in the step (5) is subjected to passage through a micrometer-order filter or a treatment of stirring in a annular type continuous-stirring mill to perform shape control so that the major/minor axis ratio falls within the prescribed range.

Specific methods for shape control of colored particles include passage through a gap, a filter or fine pores and centrifugal force applied to colored particles through high-speed rotation. Examples of a device for shape control treatment of colored particles include a piston type high-pressure homogenizer and an in-line screw pump as well as an annular type continuous-stirring mill, as described above.

Toner particles of an intended shape can be realized by controlling the treatment time, the treatment temperature and the treatment speed of the shape control treatment.

Thus, shape control of colored particles is conducted to produce colored particles of a major/minor axis ratio falling within a prescribed range.

### (6) Solvent Removal Step:

The step (6) is removal of the organic solvent from the colored particles obtained in the step (5). In the step (6), heating to a temperature higher than the boiling point of the organic solvent is conducted to remove the organic solvent. The surface property of the formed particles can be regulated by control of the solvent removing rate. Specifically, increasing the solvent removal rate forms a rugged surface, resulting in enhanced irregularity.

Specifically, externally heating at a temperature higher than the boiling point of the solvent, preferably at a temperature of the boiling point plus 5-20° C. and further under reduced pressure of, for example, 1-300 hpa can form the rugged surface. Excessively heating cannot achieve the targeted surface property. Similarly, reduced pressure not falling within the foregoing range renders it difficult to fall within the range of the invention.

Even when removing organic solvents, the presence of a specific catalytic metal ion or a specific catalytic metal compound inhibits colorant aggregation, whereby the colorant is contained in a polyester resin with maintaining a high dispersion state to produce a toner achieving high dispersion of the colorant.

### (7) Filtration and Washing Step:

In the step (7), a colored particle dispersion obtained in the step (6) is cooled and subjected to a filtration treatment in which the colored particle dispersion is filtered for solid-liquid separation to separate the colored particles from the dispersion and a washing treatment to remove adhered materials such a surfactant from the separated colored particles. Specific methods for solid-liquid separation and washing include, for example, centrifugal separation, filtration under reduced pressure by using Nutsche funnel and filtration using a filter press.

### (8) Drying Step:

In the step (8), the colored particles having been washed are subjected to a drying treatment. Drying machines usable in this drying step include, for example, a spray dryer, a vacuum freeze dryer, a vacuum dryer, a standing plate type dryer, a mobile plate type dryer, a fluidized-bed dryer, a rotary dryer and a stirring dryer. The moisture content of the thus dried colored particles is preferably not more than 5% by mass, and more preferably not more than 2% by mass.

The moisture content of colored particles is determined by Karl Fischer coulometric titration. Specifically, using an automatic heat-vaporization moisture measurement system AQS-724 (produced by Hiranuma Sangyo Co., Ltd.) constituted of a moisture meter AO-6 AQI-601 (interface for AQ-6) and a heat-vaporization device LE-24S, 0.5 g of colored particles which has been allowed to stand in an atmosphere of 20° C. and 50% RH for 24 hrs. is precisely weighed and placed into a 20 ml glass tube and sealed with Teflon-coated silicone rubber packing. The moisture content under the sealed environment is measured using reagents under the conditions described below. Two empty sample tubes is concurrently measured to correct the moisture content under the sealed environment.
Sample heating temperature: 110° C.
Sample heating time: 1 min.
Nitrogen gas flow rate: 150 ml/min
Reagent:
Opposing electrode liquid (cathode liquid);
   HYDRANAL (R)—Coulomat CG-K
Generating liquid (anode liquid);
   HYDRANAL (R)—Coulomat AK

In cases when the dried colored particles are aggregated due to a weak attractive force between particles, the aggregate may be disintegrated by using a disintegrating device, such as a jet mill, a Henschel mixer, a coffee mil or a food processor.

### (9) External Additive Addition Step:

In the step (9), a charge controlling agent, various organic or inorganic microparticles and a lubricant are incorporated to the dried toner particles to improve fluidity or an electrostatic property and to enhance cleaning capability. Examples of a device used for adding external additives include a turbulent mixer, a Henschel mixer, a Nauta mixer or a V-type mixer. For instance, inorganic particles of silica, titania or alumina are preferably used and preferably, these inorganic particles are subjected to a treatment for hydrophobicity, using a silane coupling agent or a titanium coupling agent. External additives are incorporated preferably in an amount of 0.1 to 5.0% by mass of the toner, and more preferably 0.5 to 4.0% by mass. External additives may be used singly or in combination.

The acid value of a polyester resin constituting the thus obtained toner is preferably from 5 to 45 mg KOH/g and more preferably from 5 to 30 mg KOH/g. A polyester resin exhibiting an excessive acid value is easily subject to environmental effects when the image formation operation is conducted under high temperature and high humidity, or low temperature and low humidity, and there is concern of causing deterioration of the formed images.

The glass transition point (Tg) of a polyester resin is preferably from 30 to 60° C., and more preferably from 35 to 54° C. and the softening point is preferably from 70 to 130° C. and more preferably from 80 to 120° C. The glass transition point (Tg) and the softening point are measured using a toner as a sample, similarly to the manner as described earlier.

The weight average molecular weight of a polyester resin is preferably from 5,000 to 500,000, and more preferably from 10,000 to 100,000; the number average molecular weight of a polyester resin is preferably from 3,500 to 400,000, and more preferably from 7,000 to 80,000. When a molecular weight of a polyester resin falls within the foregoing range, sufficient low temperature fixability and superior adhesion onto a recording material which are due to urea modification are realized and crushing of toner particles inside a development device is inhibited, and further, enhanced strength of a fixed image is achieved. A polyester resin of an excessively small molecular weight results in a low melt viscosity and achieves sufficient low temperature fixability but results in slightly lowered strength of the toner particles. That is also concern that the toner particles are crushed by stress inside a development device or the strength of the fixed image is lowered. A polyester resin of an excessively large molecular weight results in a low melt viscosity and results in concern that adhesion onto a recording material is insufficient. The molecular weight of a polyester resin is measured using a toner as a sample, similarly to the manner as described earlier.

When a binding resin is comprised of a urea-modified polyester resin, negative electrostatic-charging capability held the polyester resin is reduced due to a urea bonding, whereby excessive-charging is inhibited and enhanced charging stability is achieved and also superior adhesion onto the recording material is also realized. Formation of ester bonding and urea bonding in the molecule results in enhanced internal cohesion, leading to improved crushing resistance.

### Developer

When using the toner of the invention as a single-component developer by incorporating a magnetic material or as a two-component developer by mixing a so-called carrier, a nonmagnetic toner can be used alone.

When using the toner as a two-component developer by mixing a carrier, toner filming (carrier staining) onto the carrier is inhibited, and when using the toner as a single-component developer, toner filming occurring in a frictionally charging member of a development device is inhibited.

There are usable commonly known materials as a carrier constituting a two-component developer, including, for example, metals such as iron, ferrite and magnetite, and alloys of metals such as aluminum or lead. Of these, ferrite particles are preferred.

The volume-average particle size of a carrier is preferably from 15 to 100 μm, and more preferably 25 to 60 μm. The volume-average particle size of the carrier can be determined using a laser diffraction type particle size distribution measurement apparatus provided with a wet disperser, HELOS (produced by SYMPATEC Corp.).

Preferred carriers include resin-coated carrier in which the surface of magnetic particles is covered with resin and a resin dispersion type carrier in which magnetic particles are dispersed in resin. Resins constituting the resin coated carrier are not specifically limited but an olefin resin, a styrene resin, a styrene/acryl resin, a silicone resin, an ester resin, or a fluorine-containing polymer resin is usable. Resins constituting the resin dispersion type carrier are not specifically limited but a polyester resin, a fluororesin, or a phenol resin is usable.

### Image Forming Method

The toner described above is suitable in an image forming method including a fixing step by a contact heating system. In this image forming method, an electrostatic latent image which has been electrostatically formed on an image bearing body is developed by allowing the developer to be electrostatically charged by a frictional-charging member in a developing device to obtain a toner image and the obtained toner image is transferred onto a recording material, thereafter, the transferred toner image is onto the recording material fixed by a contact-heating system to obtain a visible image.

### Fixing

As a suitable fixing method used in the image forming method as described above is cited a so-called contact heating system. Specific examples of such a contact heating system include a thermo-pressure fixing system, a heated roll fixing system and a pressure heat-fixing system in which fixing is performed by a fixed rotatable pressure member enclosing a heating body.

A fixing method of a heated roll fixing system employs a fixing device constituted of a upper roller formed of a fluororesin-coated metal cylinder comprised of iron or aluminum and having a heat source built-in and a lower roller formed of silicone rubber. As a heat source is used a linear heater, which heats the upper roller surface to a temperature of 120 to 200° C. Pressure is applied between the upper and lower rollers and the pressure deforms the lower roller, whereby a nip is formed in the deformed portion. The nip depth is usually from 1 to 10 mm and preferably from 1.5 to 7 mm. The linear fixing speed is preferably from 40 to 600 mm/sec. An excessively small nip depth renders it difficult to provide uniformly heat to the toner, resulting in fixing unevenness. An excessively large nip depth promotes melting of the polyester resin contained in the toner, resulting in fixing offset.

In the toner described above, toner particles comprise a polyester resin and exhibit a specific minute particle size, whereby a high quality image can be obtained; exhibiting a specific sharp particle size dispersion degree, whereby formation of excessively smaller toner particles or excessively larger particles is inhibited and a high density of toner particles is achieved in fixing; exhibiting a specific irregular form, whereby the space between toner particles is minimized and closer contact of toner particles is achieved in fixing, preventing diffusion of the toner and leading to enhanced fine line reproducibility and higher image density; and containing a specific catalytic metal element in a specific amount, whereby enhanced dispersibility of a colorant in a binding resin of fine toner particles is enhanced, whereby higher image density and broader color reproduction range are achieved even at a reduced power consumption and higher quality image is realized.

In the afore-described manufacturing method of a toner, a specific catalytic compound is used in synthesis of the polyester segment and still remains therein, resulting in homogeneous existence of the catalytic compound in a polyester resin and the catalytic compound being oriented for a colorant, achieving enhanced dispersion of the colorant, whereby a toner containing a highly dispersed colorant in a polyester resin is obtained.

Embodiments of the invention have been described but are not limited to these and various changes and modification can be made therein.

### EXAMPLES

The invention will be further described with reference to examples but is by no means limited to these.

Synthesis of Polyester Segment (a1):

Into a reaction vessel fitted with a stirrer and a nitrogen-introducing tube were placed 724 parts by mass of bisphenol A with 2 mole ethylene oxide adduct, 200 parts by mass of isophthalic acid, 70 parts by mass of fumaric acid and 2 parts by mass (0.2% by mass) of tetra-n-butyl titanate and reacted at 220° C. under normal pressure for 7 hrs. Further, after reacted under reduced pressure of 10 mm Hg for 4 hrs., the reaction mixture was cooled to 160° C., then, 32 parts by mass of phthalic acid anhydride was added thereto and reacted for 2 hrs. to obtain a polyester segment (a1). The polyester segment (a1) exhibited a glass transition point (Tg) of 52° C., a softening point of 108° C., a number average molecular weight (Mn) of 4,300 and a weight average molecular weight (Mw) of 22,000.

### Synthesis of Isocyanate-modified Polyester Segment (A1):

To 1,000 parts by mass of the polyester segment (a1) was added 2,000 parts by mass of ethyl acetate, then, 120 parts by mass of isophorone diisocyanate was added thereto and reacted at 80° C. for 2 hrs. to obtain an isocyanate-modified polyester segment (A1).

Synthesis of Polyester Segment (a2):

Into a reaction vessel fitted with a stirrer and a nitrogen-introducing tube were placed 250 parts by mass of bisphenol A with 2 mole ethylene oxide adduct, 53 parts by mass of ethylene glycol, 200 parts by mass of isophthalic acid, 70 parts by mass of fumaric acid and 3 parts by mass of tetra-isopropyl titanate (0.4% by mass) and reacted at 220° C. under normal pressure for 5 hrs. Further, after reacted under reduced pressure of 10 mm Hg for 4 hrs., the reaction mixture was cooled to 160° C., then, 32 parts by mass of phthalic acid anhydride was added thereto and reacted for 2 hrs. to obtain a polyester segment (a2). The polyester segment (a2) exhibited a glass transition point (Tg) of 46 ° C., a softening point of 103° C., a number average molecular weight (Mn) of 4,000 and a weight average molecular weight (Mw) of 31,000.

### Synthesis of Isocyanate-modified Polyester Segment (A2):

To 1,000 parts by mass of the polyester segment (a2) was added 2,000 parts by mass of ethyl acetate, then, 130 parts by mass of isophorone diisocyanate was added thereto and reacted at 80° C. for 2 hrs. to obtain an isocyanate-modified polyester segment (A2).

Synthesis of Polyester Segment (a3):

Polyester segment (a3) was prepared similarly to the foregoing polyester segment (a1), provided that 2 parts by mass (0.2% by mass) of tetra-n-butyl titanate was replaced by 6 parts by mass (0.6% by mass) of titanium octylene glycol. The polyester segment (a3) exhibited a glass transition point (Tg) of 51° C., a softening point of 105° C., a number average molecular weight (Mn) of 4,000 and a weight average molecular weight (Mw) of 21,000.

### Synthesis of Isocyanate-modified Polyester Segment (A3):

To 1,000 parts by mass of the polyester segment (a3) was added 2,000 parts by mass of ethyl acetate, then, 120 parts by mass of isophorone diisocyanate was added thereto and reacted at 80° C. for 2 hrs. to obtain an isocyanate-modified polyester segment (A3).

Synthesis of Polyester Segment (a4):

Polyester segment (a4) was prepared similarly to the foregoing polyester segment (a1), provided 2.0 parts by mass (0.2% by mass) of tetra-n-butyl titanate was replaced by 2.5 parts by mass (0,25% by mass) of germanium dioxide. The polyester segment (a4) exhibited a glass transition point (Tg) of 50° C., a softening point of 102° C., a number average molecular weight (Mn) of 3,900 and a weight average molecular weight (Mw) of 19,000.

### Synthesis of Isocyanate-modified Polyester Segment (A4):

To 1,000 parts by mass of the polyester segment (a4) was added 2,000 parts by mass of ethyl acetate, then, 120 parts by mass of isophorone diisocyanate was added thereto and reacted at 80° C. for 2 hrs. to obtain an isocyanate-modified polyester segment (A4).

Synthesis of Polyester Segment (a5):

Polyester segment (a5) was prepared similarly to the foregoing polyester segment (a1), provided 2.0 parts by mass (0.2% by mass) of tetra-n-butyl titanate was replaced by 8 parts by mass (0.8% by mass) of trioctyl aluminate. The polyester segment (a5) exhibited a glass transition point (Tg) of 51° C., a softening point of 105° C., a number average molecular weight (Mn) of 4,600 and a weight average molecular weight (Mw) of 22,000.

### Synthesis of Isocyanate-modified Polyester Segment (A5):

To 1,000 parts by mass of the polyester segment (a5) was added 2,000 parts by mass of ethyl acetate, then, 120 parts by mass of isophorone diisocyanate was added thereto and reacted at 80° C. for 2 hrs. to obtain an isocyanate-modified polyester segment (A5).

Synthesis of Polyester Segment (b1):

Polyester segment (b1) was prepared similarly to the foregoing polyester segment (a1), provided 2.0 parts by mass (0.2% by mass) of tetra-n-butyl titanate was replaced by 2 parts by mass (0.2% by mass) of tributyl tin. The polyester segment (b1) for comparison exhibited a glass transition point (Tg) of 48° C., a softening point of 102° C., a number average molecular weight (Mn) of 3,200 and a weight average molecular weight (Mw) of 18,000.

### Synthesis of Isocyanate-modified Polyester Segment (B1):

To 1,000 parts by mass of the polyester segment (b1) was added 2,000 parts by mass of ethyl acetate, then, 120 parts by mass of isophorone diisocyanate was added thereto and reacted at 80° C. for 2 hrs. to obtain an isocyanate-modified polyester segment (B1) for comparison.

Synthesis of Polyester Segment (b2):

Polyester segment (b2) was prepared similarly to the foregoing polyester segment (a4), provided that the amount of germanium dioxide was changed from 2.5 parts by mass (0.5% by mass) to 5 parts by mass (0.5% by mass). The polyester segment (b2) for comparison exhibited a glass transition point (Tg) of 49° C., a softening point of 109° C., a number average molecular weight (Mn) of 4,000 and a weight average molecular weight (Mw) of 28,000.

### Synthesis of Isocyanate-modified Polyester Segment (B2):

To 1,000 parts by mass of the polyester segment (b2) was added 2,000 parts by mass of ethyl acetate, then, 120 parts by mass of isophorone diisocyanate was added thereto and reacted at 80° C. for 2 hrs. to obtain an isocyanate-modified polyester segment (B2) for comparison.

### Manufacture of Toner Bk1:

In a mixing bath fitted with a liquid seal (reflux condenser) and a stirrer were mixed 900 parts by mass of ethyl acetate, 300 parts by mass of isocyanate-modified polyester segment (A1), 4 parts by mass of copper phthalocyanine blue, 4 parts by mass of carbon black, 15 parts by mass of pentaerythritol tetrastearate and 5 parts by mass of isophoronediamine at 20° C. for 2 hrs. to obtain a toner forming material solution.

Into another reaction vessel were placed 600 parts by mass of deionized water, 60 parts by mass of methyl ethyl ketone, 60 parts by mass of tricalcium phosphate and 0.3 parts by mass of sodium dodecylbenzenesulfonate and further thereto, the foregoing toner forming material solution was added and dispersed in the form of oil-droplets dispersed in an aqueous medium and having a number average particle size of 0.5 μm, while stirring at 30° C. by a TY-type homomixer (produced by Tokushukika Kogyo Co. Ltd.) at 15,000 rpm over a period of 3 min. Thereafter, the foregoing homomixer was replaced by a conventional stirrer, the temperature was raised to 80° C. with stirring at 300 rpm and stirred for 3 hrs. to perform molecular an elongation reaction to obtain polyester microparticles and coagulation of the obtained polyester microparticles. The coagulated particles exhibited a volume-based median diameter of 6.9 μm. Then, the temperature was raised to 95° C. to remove ethyl acetate. After removal of ethyl acetate continued until ethyl acetate completely disappeared, 150 parts by mass of a concentrated 35% hydrochloric acid was added thereto to dissolve tricalcium phosphate on the toner particle surface. Subsequently, solid-liquid separation was performed and a dehydrated toner cake was dispersed in deionized water. After repeating solid-liquid separation three times to perm washing, drying was done at 40° C. for 24 hrs, to obtain toner particles (Bk1). To the obtained toner particles (Bk1) were added 0.6 parts by mass of a hydrophobic silica and 1.0 part by mass of a hydrophobic titanium oxide and mixed by a Henschel Mixer to obtain a toner (Bk1), in which the toner was mixed at 32° C. by a Heuschel Mixer at 35 m/sec for 20 min and passed through a sieve having an aperture of 34 μm.

The toner (Bk1) exhibited a volume-based median diameter of 5.6 μm, an average circularity of 0.968, a glass transition point (Tg) of 54° C., a softening point of 113° C., a number average molecular eight (Mn) of 8,000 and a weight average molecular weight (Mw) of 34,000. The volume-based particle size dispersion degree (CVᵥₒₗ value) was 19 and the content of a specific catalytic metal element (titanium) was 250 ppm.

### Manufacture of Toner (Y1):

Toner (Y1) was manufactured similarly to the foregoing toner (Bk1), provided that 4 parts by mass of copper phthalocyanine blue and 4 parts by mass of carbon black were replaced by 8 parts by mass of Pigment Yellow 74.

The toner (Y1) exhibited a volume-based median diameter of 5.7 μm, an average circularity of 0.971, a glass transition point (Tg) of 54° C., a softening point of 113° C., a number average molecular eight (Mn) of 8,000 and a weight average molecular weight (Mw) of 34,000. The volume-based particle size dispersion degree (CVᵥₒₗ value) was 19 and the content of a specific catalytic metal element (titanium) was 250 ppm.

### Manufacture of Toner (M1):

Toner (M1) was manufactured similarly to the foregoing toner (Bk1), provided that 4 parts by mass of copper phthalocyanine blue and 4 parts by mass of carbon black were replaced by 8 parts by mass of Pigment Red 238.

The toner (M1) exhibited a volume-based median diameter of 5.7 μm, an average circularity of 0.969, a glass transition point (Tg) of 54° C., a softening point of 113° C., a number average molecular eight (Mn) of 8,000 and a weight average molecular weight (Mw) of 34,000. The volume-based particle size dispersion degree (CVᵥₒₗ value) was 19 and the content of a specific catalytic metal element (titanium) was 250 ppm.

### Manufacture of Toner (C1):

Toner (C1) was manufactured similarly to the foregoing toner (Bk1), provided that 4 parts by mass of copper phthalocyanine blue and 4 parts by mass of carbon black were replaced by 8 parts by mass of copper phthalocyanine blue.

The toner (Y1) exhibited a volume-based median diameter of 5.7 μm, an average circularity of 0.970, a glass transition point (Tg) of 54° C., a softening point of 113° C., a number average molecular eight (Mn) of 8,000 and a weight average molecular weight (Mw) of 34,000. The volume-based particle size dispersion degree (CVᵥₒₗ value) was 19 and the content of a specific catalytic metal element (titanium) was 250 ppm.

### Manufacture of Toner (Bk2):

Toner (Bk2) was manufactured similarly to the foregoing toner (Bk1), provided that isocyanate-modified polyester segment (A1) was replaced by isocyanate-modified polyester segment (A2).

The toner (Bk2) exhibited a volume-based median diameter of 5.6 μm, an average circularity of 0.965, a glass transition point (Tg) of 54° C., a softening point of 109° C., a number average molecular eight (Mn) of 7,900 and a weight average molecular weight (Mw) of 58,000. The volume-based particle size dispersion degree (CVᵥₒₗ value) was 19 and the content of a specific catalytic metal element (titanium) was 500 ppm.

### Manufacture of Toner (Y2):

Toner (Y2) was manufactured similarly to the foregoing toner (Y1), provided that isocyanate-modified polyester segment (A1) was replaced by isocyanate-modified polyester segment (A2).

The toner (Y2) exhibited a volume-based median diameter of 5.6 μm, an average circularity of 0.966, a glass transition point (Tg) of 54° C., a softening point of 109° C., a number average molecular eight (Mn) of 7,900 and a weight average molecular weight (Mw) of 58,000. The volume-based particle size dispersion degree (CVᵥₒₗ value) was 19 and the content of a specific catalytic metal element (titanium) was 500 ppm.

### Manufacture of Toner (M2):

Toner (M2) was manufactured similarly to the foregoing toner (M1), provided that isocyanate-modified polyester segment (A1) was replaced by isocyanate-modified polyester segment (A2).

The toner (M2) exhibited a volume-based median diameter of 5.6 μm, an average circularity of 0.968, a glass transition point (Tg) of 54° C., a softening point of 109° C., a number average molecular eight (Mn) of 7,900 and a weight average molecular weight (Mw) of 58,000. The volume-based particle size dispersion degree (CVᵥₒₗ value) was 19 and the content of a specific catalytic metal element (titanium) was 500 ppm.

### Manufacture of Toner (C2):

Toner (C2) was manufactured similarly to the foregoing toner (C1), provided that isocyanate-modified polyester segment (A1) was replaced by isocyanate-modified polyester segment (A2).

The toner (C2) exhibited a volume-based median diameter of 5.6 μm, an average circularity of 0.968, a glass transition point (Tg) of 54° C., a softening point of 109° C., a number average molecular eight (Mn) of 7,900 and a weight average molecular weight (Mw) of 58,000. The volume-based particle size dispersion degree (CVᵥₒₗ value) was 19 and the content of a specific catalytic metal element (titanium) was 500 ppm.

### Manufacture of Toner (Bk3):

Toner (Bk3) was manufactured similarly to the foregoing toner (Bk1), provided that isocyanate-modified polyester segment (A1) was replaced by isocyanate-modified polyester segment (A3).

The toner (Bk3) exhibited a volume-based median diameter of 5.6 μm, an average circularity of 0.971, a glass transition point (Tg) of 58° C., a softening point of 110° C., a number average molecular eight (Mn) of 7,600 and a weight average molecular weight (Mw) of 39,000. The volume-based particle size dispersion degree (CVᵥₒₗ value) was 19 and the content of a specific catalytic metal element (titanium) was 650 ppm.

### Manufacture of Toner (Y3)

Toner (Y3) was manufactured similarly to the foregoing toner (Y1), provided that isocyanate-modified polyester segment (A1) was replaced by isocyanate-modified polyester segment (A3).

The toner (Y3) exhibited a volume-based median diameter of 5.6 μm, an average circularity of 0.970, a glass transition point (Tg) of 58° C., a softening point of 110° C., a number average molecular eight (Mn) of 7,600 and a weight average molecular weight (Mw) of 39,000. The volume-based particle size dispersion degree (CVᵥₒₗ value) was 19 and the content of a specific catalytic metal element (titanium) was 650 ppm.

### Manufacture of Toner (M3):

Toner (M3) was manufactured similarly to the foregoing toner (Y1), provided that isocyanate-modified polyester segment (A1) was replaced by isocyanate-modified polyester segment (A3).

The toner (M3) exhibited a volume-based median diameter of 5.6 μm, an average circularity of 0.969, a glass transition point (Tg) of 58° C., a softening point of 110° C., a number average molecular eight (Mn) of 7,600 and a weight average molecular weight (Mw) of 39,000. The volume-based particle size dispersion degree (CVᵥₒₗ value) was 19 and the content of a specific catalytic metal element (titanium) was 650 ppm.

### Manufacture of Toner (C3):

Toner (C3) was manufactured similarly to the foregoing toner (C1), provided that isocyanate-modified polyester segment (A1) was replaced by isocyanate-modified polyester segment (A3).

The toner (Y3) exhibited a volume-based median diameter of 5.6 μm, an average circularity of 0.968, a glass transition point (Tg) of 58° C., a softening point of 110° C., a number average molecular eight (Mn) of 7,600 and a weight average molecular weight (Mw) of 39,000. The volume-based particle size dispersion degree (CVᵥₒₗ value) was 19 and the content of a specific catalytic metal element (titanium) was 650 ppm.

### Manufacture of Toner (Bk4):

Toner (Bk4) was manufactured similarly to the foregoing toner (Bk1), provided that isocyanate-modified polyester segment (A1) was replaced by isocyanate-modified polyester segment (A4).

The toner (Bk4) exhibited a volume-based median diameter of 5.6 μm, an average circularity of 0.972, a glass transition point (Tg) of 58° C., a softening point of 109° C., a number average molecular eight (Mn) of 6,700 and a weight average molecular weight (Mw) of 34,600. The volume-based particle size dispersion degree (CVᵥₒₗ value) was 18 and the content of a specific catalytic metal element (titanium) was 1200 ppm.

### Manufacture of Toner (Y4):

Toner (Y4) was manufactured similarly to the foregoing toner (Y1), provided that isocyanate-modified polyester segment (A1) was replaced by isocyanate-modified polyester segment (A4).

The toner (Y4) exhibited a volume-based median diameter of 5.6 μm, an average circularity of 0.971, a glass transition point (Tg) of 56° C., a softening point of 109° C., a number average molecular eight (Mn) of 6,700 and a weight average molecular weight (Mw) of 34,600. The volume-based particle size dispersion degree (CVᵥₒₗ value) was 18 and the content of a specific catalytic metal element (titanium) was 1200 ppm.

### Manufacture of Toner (M4):

Toner (M4) was manufactured similarly to the foregoing toner (M1), provided that isocyanate-modified polyester segment (A1) was replaced by isocyanate-modified polyester segment (A4).

The toner (M4) exhibited a volume-based median diameter of 5.6 μm, an average circularity of 0.971, a glass transition point (Tg) of 56° C., a softening point of 109° C., a number average molecular eight (Mn) of 6,700 and a weight average molecular weight (Mw) of 34,600. The volume-based particle size dispersion degree (CVᵥₒₗ value) was 18 and the content of a specific catalytic metal element (titanium) was 1200 ppm.

### Manufacture of Toner (C4):

Toner (C4) was manufactured similarly to the foregoing toner (C1), provided that isocyanate-modified polyester segment (A1) was replaced by isocyanate-modified polyester segment (A4).

The toner (C4) exhibited a volume-based median diameter of 5.6 μm, an average circularity of 0.9768, a glass transition point (Tg) of 56° C., a softening point of 109° C., a number average molecular eight (Mn) of 6,700 and a weight average molecular weight (Mw) of 34,600. The volume-based particle size dispersion degree (CVᵥₒₗ value) was 18 and the content of a specific catalytic metal element (titanium) was 1200 ppm.

### Manufacture of Toner (Bk5):

Toner (Bk5) was manufactured similarly to the foregoing toner (Bk1), provided that isocyanate-modified polyester segment (A1) was replaced by isocyanate-modified polyester segment (A5).

The toner (Bk5) exhibited a volume-based median diameter of 5.6 μm, an average circularity of 0.967, a glass transition point (Tg) of 59° C., a softening point of 112° C., a number average molecular eight (Mn) of 8,300 and a weight average molecular weight (Mw) of 38,000. The volume-based particle size dispersion degree (CVᵥₒₗ value) was 19 and the content of a specific catalytic metal element (titanium) was 400 ppm.

### Manufacture of Toner (Y5):

Toner (Y5) was manufactured similarly to the foregoing toner (Y1), provided that isocyanate-modified polyester segment (A1) was replaced by isocyanate-modified polyester segment (A5).

The toner (Y5) exhibited a volume-based median diameter of 5.6 μm, an average circularity of 0.968, a glass transition point (Tg) of 59° C., a softening point of 112° C., a number average molecular eight (Mn) of 8,300 and a weight average molecular weight (Mw) of 38,000. The volume-based particle size dispersion degree (CVᵥₒₗ value) was 19 and the content of a specific catalytic metal element (titanium) was 400 ppm.

### Manufacture of Toner (M5):

Toner (M5) was manufactured similarly to the foregoing toner (M1), provided that isocyanate-modified polyester segment (A1) was replaced by isocyanate-modified polyester segment (A5).

The toner (M5) exhibited a volume-based median diameter of 5.6 μm, an average circularity of 0.969, a glass transition point (Tg) of 59° C., a softening point of 112° C., a number average molecular eight (Mn) of 8,300 and a weight average molecular weight (Mw) of 38,000. The volume-based particle size dispersion degree (CVᵥₒₗ value) was 19 and the content of a specific catalytic metal element (titanium) was 400 ppm.

### Manufacture of Toner (C5):

Toner (C5) was manufactured similarly to the foregoing toner (C1), provided that isocyanate-modified polyester segment (A1) was replaced by isocyanate-modified polyester segment (A5).

The toner (C5) exhibited a volume-based median diameter of 5.6 μm, an average circularity of 0.969, a glass transition point (Tg) of 59° C., a softening point of 112° C., a number average molecular eight (Mn) of 8,300 and a weight average molecular weight (Mw) of 38,000. The volume-based particle size dispersion degree (CVᵥₒₗ value) was 19 and the content of a specific catalytic metal element (titanium) was 400 ppm.

Manufacture of Toner (bk1):

Toner (bk1) for comparison was manufactured similarly to the foregoing toner (Bk1), provided that isocyanate-modified polyester segment (A1) was replaced by isocyanate-modified polyester segment (B1).

The toner (bk1) exhibited a volume-based median diameter of 5.6 μm, an average circularity of 0.974, a glass transition point (Tg) of 56° C., a softening point of 110° C., a number average molecular eight (Mn) of 6,000 and a weight average molecular weight (Mw) of 32,000. The volume-based particle size dispersion degree (CVᵥₒₗ value) was 19 and the content of tin was 800 ppm.

Manufacture of Toner (y1):

Toner (y1) for comparison was manufactured similarly to the foregoing toner (Y1), provided that isocyanate-modified polyester segment (A1) was replaced by isocyanate-modified polyester segment (B1).

The toner (y1) exhibited a volume-based median diameter of 5.6 μm, an average circularity of 0.974, a glass transition point (Tg) of 56° C., a softening point of 110° C., a number average molecular eight (Mn) of 6,000 and a weight average molecular weight (Mw) of 32,000. The volume-based particle size dispersion degree (CVᵥₒₗ value) was 19 and the content of tin was 800 ppm.

Manufacture of Toner (m1):

Toner (m1) for comparison was manufactured similarly to the foregoing toner (Y1), provided that isocyanate-modified polyester segment (A1) was replaced by isocyanate-modified polyester segment (B1).

The toner (m1) exhibited a volume-based median diameter of 5.6 μm, an average circularity of 0.972, a glass transition point (Tg) of 56° C., a softening point of 110° C., a number average molecular eight (Mn) of 6,000 and a weight average molecular weight (Mw) of 32,000. The volume-based particle size dispersion degree (CVᵥₒₗ value) was 19 and the content of tin was 800 ppm.

Manufacture of Toner (c1):

Toner (c1) for comparison was manufactured similarly to the foregoing toner (C1), provided that isocyanate-modified polyester segment (A1) was replaced by isocyanate-modified polyester segment (B1).

The toner (c1) exhibited a volume-based median diameter of 5.6 μm, an average circularity of 0.971, a glass transition point (Tg) of 56° C., a softening point of 110° C., a number average molecular eight (Mn) of 6,000 and a weight average molecular weight (Mw) of 32,000. The volume-based particle size dispersion degree (CVᵥₒₗ value) was 19 and the content of tin was 800 ppm.

Manufacture of Toner (bk2):

Toner (bk2) for comparison was manufactured similarly to the foregoing toner (bk1), provided that isocyanate-modified polyester segment (A1) was replaced by isocyanate-modified polyester segment (B2).

The toner (bk2) exhibited a volume-based median diameter of 5.6 μm, an average circularity of 0.974, a glass transition point (Tg) of 59° C., a softening point of 112° C., a number average molecular eight (Mn) of 7,000 and a weight average molecular weight (Mw) of 36,000. The volume-based particle size dispersion degree (CVᵥₒₗ value) was 19 and the content of a specific catalytic metal (germanium) was 1600 ppm.

Manufacture of Toner (y2):

Toner (y2) for comparison was manufactured similarly to the foregoing toner (Y1), provided that isocyanate-modified polyester segment (A1) was replaced by isocyanate-modified polyester segment (B2).

The toner (y2) exhibited a volume-based median diameter of 5.6 μm, an average circularity of 0.974, a glass transition point (Tg) of 59° C., a softening point of 112° C., a number average molecular eight (Mn) of 7,000 and a weight average molecular weight (Mw) of 36,000. The volume-based particle size dispersion degree (CVᵥₒₗ value) was 19 and the content of a specific catalytic metal (germanium) was 1600 ppm.

Manufacture of Toner (m2):

Toner (m2) for comparison was manufactured similarly to the foregoing toner (M1), provided that isocyanate-modified polyester segment (A1) was replaced by isocyanate-modified polyester segment (B2).

The toner (m2) exhibited a volume-based median diameter of 5.6 μm, an average circularity of 0.972, a glass transition point (Tg) of 59° C., a softening point of 112° C., a number average molecular eight (Mn) of 7,000 and a weight average molecular weight (Mw) of 36,000. The volume-based particle size dispersion degree (CVᵥₒₗ value) was 19 and the content of a specific catalytic metal (germanium) was 1600 ppm.

Manufacture of Toner (c2):

Toner (c2) for comparison was manufactured similarly to the foregoing toner (C1), provided that isocyanate-modified polyester segment (A1) was replaced by isocyanate-modified polyester segment (B2).

The toner (c2) exhibited a volume-based median diameter of 5.6 μm, an average circularity of 0.971, a glass transition point (Tg) of 59° C., a softening point of 112° C., a number average molecular eight (Mn) of 7,000 and a weight average molecular weight (Mw) of 36,000. The volume-based particle size dispersion degree (CVᵥₒₗ value) was 19 and the content of a specific catalytic metal (germanium) was 1600 ppm.

### Manufacture of Carrier:

Manganese-magnesium ferrite particles having a weight average particle size of 50 μm were spray-coated with a coating agent composed of 85 parts by weight (solids) of silicone resin (oxime-hardening type, toluene solution), 10 parts by weight of y-aminopropyltrimethoxysilane (coupling agent), 3 parts by weight of alumina particles (particle size of 100 nm) and 2 parts by weight of carbon black, were subjected to sintering at 190° C. for 6 hrs. and then cooled to normal temperature to obtain a resin-coated carrier. The average thickness of the resin coat was 0.2 μm.

### Manufacture of Developer:

Using a V-type mixing machine, 94 parts by weight of the thus manufactured carrier was mixed with 6 parts by weight of each of manufactured toners (Bk-1) through (C5) and toners for comparison (bk1) through (c2) to manufacture developers (Bk1) through (C5) and developers for comparison (y1) through (c2). In the mixing treatment, mixing was stopped when an electrostatic charge reached 20-23 μC/g and the developer was discharged into a polyethylene pot.

Using the thus manufactured developers, image formation was conducted and evaluated as below.

### Evaluation of Monochromatic Image:

Using each of developers (Bk1)-(Bk5) and developers for comparison (bk1) and (bk2), a black solid image (5×5 cm) was prepared by using a digital copier, bizhub C500 (produced by Konica Minolta Corp.) under high temperature and high humidity (35° C., 85% RH). A reflection density of the black solid image was measured via a reflection densitometer, RD-918 (produced by Macbeth Corp.). The reflection density was represented by a relative value, based on the reflection density of paper being 0. Further, under high temperature and high humidity (35° C., 85% RH), 50,000 sheets of the black solid image were printed in a one-sheet intermittent mode in which after one sheet was printed, stoppage was taken for sec. and the 50,000 th sheet was evaluated with respect to image density and fog density.

Using developers (Y1)-(C) and developers for comparison (y1)-(c2) in combination shown in Table 2, solid images (2×2 cm) of yellow (Y), magenta (M), cyan (C), blue (B), green (G) and red (R), and the respective color regions were each measured and represented in the a*-b* coordinates, in which an area of a color reproducible region was determined and represented by a relative value, based on the area of a color reproduction region constituted by the respective color region of Y/M/C/R/G/B of corresponding to Japan Color for printing, being 100.

TABLE 1

| | | | | After Printing | |
|---|---|---|---|---|---|
| | | Start | | of 50,000 Sheets | |
| | | Image | Fog | Image | Fog |
| | Developer | Density | Density | Density | Density |
| Example 1 | Bk 1 | 1.45 | 0 | 1.44 | 0.001 |
| Example 2 | Bk 2 | 1.44 | 0 | 1.44 | 0.001 |
| Example 3 | Bk 3 | 1.44 | 0 | 1.43 | 0.001 |
| Example 4 | Bk 4 | 1.45 | 0 | 1.43 | 0.003 |
| Example 5 | Bk 5 | 1.44 | 0 | 1.43 | 0.001 |
| Comparison 1 | bk 1 | 1.36 | 0 | 1.32 | 0.005 |
| Comparison 2 | bk 2 | 1.42 | 0.001 | 1.42 | 0.014 |

TABLE 2

| | Combination of | Color Reproduction |
|---|---|---|
| | Developers | Region |
| Example 1 | Y1/M1/C1 | 118 |
| Example 2 | Y2/M2/C2 | 117 |
| Example 3 | Y3/M3/C3 | 117 |
| Example 4 | Y4/M4/C4 | 115 |
| Example 5 | Y5/M5/C5 | 117 |
| Comparison 1 | y1/m1/c1 | 98 |
| Comparison 2 | Y2/m2/c2 | 118 |

As apparent form Tables 1 and 2, it was proved that toners relating to Examples 1-5 attained enhanced electrostatic-charging stability over a long duration and color images achieved a broad color reproduction region. On the contrary, it was also proved that a tin compound resulted in inferior dispersion of a colorant in a polyester resin, rendering it difficult to achieve a broad color reproduction region, as shown in Comparison 1 and an excessive content of a specific catalytic metal element resulted in aging variation in charging property under high temperature and high humidity, rendering it difficult to achieve image formation of high quality over a long duration.

What is claimed is:

1. A toner comprising toner particles comprising a binding resin and a colorant, wherein the toner particles exhibit an average circularity of 0.950 to 0.980, a volume-based median diameter of 4.5 to 8.0 μm and a volume-based particle size dispersion degree (CVᵥₒₗ) of 15 to 25 and contain a metal element selected from the group consisting of titanium, germanium and aluminum in an amount of 10 to 1500 ppm.

2. The toner of claim 1, wherein the toner particles exhibit an average circularity of 0.955 to 0.975.

3. The toner of claim 1, wherein the toner particles exhibit a volume-based particle size dispersion degree (CVᵥₒₗ) of 15 to 22.

4. The toner of claim 1, wherein the metal element is titanium.

5. The toner of claim 1, wherein the metal element is germanium.

6. The toner of claim 1, wherein the metal element is aluminum.

7. The toner of claim 1, wherein the polyester resin exhibits a glass transition point of 30 to 60° C.

8. The toner of claim 1, wherein the polyester resin exhibits a softening point of 70 to 130° C.

9. The toner of claim 1, wherein the polyester resin exhibits a weight average molecular weight of 5,000 to 500,000.

10. The toner of claim 1, wherein the polyester resin exhibits a number average molecular weight of 3,500 to 400,000.

11. A method of manufacturing a toner comprising toner particles comprising a polyester resin and a colorant, the method comprising the steps of:
preparing a polyester segment,
dispersing the polyester segment and the colorant in a solvent to form a solution containing the polyester segment and the colorant,
dispersing the solution in an aqueous medium in the form of oil-droplets dispersed in the aqueous medium, and
performing granulation from the oil-droplets to form the toner particles,
wherein the polyester segment is prepared by polycondensing a polyol with a polycarboxylic acid in the presence of a metal ion selected from the group consisting of titanium, germanium and aluminum and the toner particles exhibit an average circularity of 0.950 to 0.980, a volume-based median diameter of 4.5 to 8.0 μm and a volume-based particle size dispersion degree (CVᵥₒₗ) of 15 to 25 and contain a metal element selected from the group consisting of titanium, germanium and aluminum in an amount of 10 to 1500 ppm.

12. The method of claim 11, wherein the toner particles exhibit an average circularity of 0.955 to 0.975.

13. The method of claim 11, wherein the toner particles exhibit a volume-based particle size dispersion degree (CVᵥₒₗ) of 15 to 22.

14. The method of claim 11, wherein the metal element is titanium.

15. The method of claim 11, wherein the metal element is germanium.

16. The method of claim 11, wherein the metal element is aluminum.

17. The method of claim 11, wherein the polyester resin exhibits a glass transition point of 30 to 60° C.

18. The method of claim 11, wherein the polyester resin exhibits a softening point of 70 to 130° C.

19. The method of claim 11, wherein the polyester resin exhibits a weight average molecular weight of 5,000 to 500,000.

20. The method of claim 11, wherein the polyester resin exhibits a number average molecular weight of 3,500 to 400,000.
